(19) United States
(12) Patent Application Publication
(10) Pub. No.: US 2014/0083056 A1
(43) Pub. Date: Mar. 27, 2014

(54) Apparatus and method for handling, transporting, and protecting an artist's freshly painted stretched canvas

(71) Applicant: Robert Wellington Grove, Cincinnati, OH (US)

(72) Inventor: Robert Wellington Grove, Cincinnati, OH (US)

(21) Appl. No.: 14/035,995

(22) Filed: Sep. 25, 2013

Related U.S. Application Data
(60) Provisional application No. 61/705,274, filed on Sep. 25, 2012.

(51) Int. Cl. B44D 3/00

(52) U.S. Cl. CPC B44D 3/00
USPC 53/472; 294/165

(57) ABSTRACT

A clamp and method of utilizing a container is provided for improved handling, transportation, and protection of an artist's freshly painted stretched canvas while requiring no contact with the wet paint. A clamp is attached to a stretched canvas prior to painting by holding to the stretcher bars at points located away from the painting surface. A configuration of three clamps attached to the stretcher bars enables the painting to be placed on an easel so as to provide an unobstructed painting surface. By leaving the clamps attached to the stretcher bars when a painting session is finished, an artist can grasp the clamps and easily move the wet painting to a container where the clamps remain attached and prevent the wet paint from contacting any interior surface of the container. While the container is closed, the wet painting is protected from accidental damage and unwanted debris during transport.

### CROSS-REFERENCE TO RELATED APPLICATIONS

U.S. patent application Ser. No. 61/705,274, filed Sep. 25, 2012, is hereby incorporated by reference herein in its entirety.

Provisional Application No.: 61/705,274

Provisional Application date: Sep. 25, 2012

Provisional Application Title: Clamps, Systems, Kits and Methods

Provisional Application First Named Inventor: Grove, Robert W.

### STATEMENT REGARDING FEDERALLY SPONSORED RESEARCH

Not Applicable

### REFERENCE TO SEQUENCE LISTING, A TABLE, OR A COMPUTER PROGRAM

Not Applicable

### BACKGROUND

An artist typically paints upon a conventional stretched canvas and regularly needs to handle, transport, and protect a freshly painted canvas while the paint is still wet and vulnerable to accidental damage. A wet painting on stretched canvas can be easily smudged by a foreign object coming into direct contact with the painted surface. A wet painting can also be contaminated with unwanted debris while being exposed to an open-air environment. An artist can be frustrated with an inadequate facility to overcome the vulnerability of a wet painting during the subsequent drying period that typically requires several hours, days, or weeks. The occurrence of accidental damage or unwanted debris can significantly reduce the intrinsic and/or monetary value of an artist's painting.

Prior art offers various carrying apparatus that require precarious handling of a wet canvas prior to, and in the process of using these devices. Prior art also offers various closable containers to protect wet canvases during transport. Prior art does not offer an apparatus and method that seamlessly facilitates handling, transportation, and protection of wet canvases during the entire period of a wet painting's vulnerability to accidental damage.

### BRIEF SUMMARY

An artist painting on stretched canvas will gain significant benefit from the apparatus and method provided to seamlessly facilitate and improve handling, transportation, and protection of wet paintings while requiring no contact whatsoever with the wet paint, including wet paint at the top outer edges of the painting surface.

### BRIEF DESCRIPTION OF THE SEVERAL VIEWS OF THE DRAWING

FIG. 1 is a left end elevational view of the clamp body and screw

FIG. 2 is a side elevational view of the clamp body and screw

FIG. 3 is a right end elevational view of the clamp body and screw

FIG. 4 is a top plan view of the clamp body and screw, with finger grip detail

FIG. 5 is a bottom plan view of the clamp body and screw

FIG. 6 is a left end elevational view of the clamp body and an attached segment of typical stretched canvas

FIG. 7 is a side elevational view of the clamp body and screw and an attached segment of typical stretched canvas

FIG. 8 is a top plan view of the clamp body and screw and an attached segment of typical stretched canvas

FIG. 9 is a plan view of a configuration of a typical stretched canvas with three clamp assemblies attached and placed on easel for painting

FIG. 10 is a side elevational view of a configuration of a typical stretched canvas with three clamp assemblies attached and placed on easel for painting

FIG. 11 is a side elevational view of appropriate box-style container and a typical stretched canvas with three clamp assemblies attached and placed into a container for transportation and protection

FIG. 12 is a partial end elevational view of appropriate box-style container and a typical stretched canvas with three clamp assemblies attached placed into a container for transportation and protection

FIG. 13 is a side elevational view of an enhanced container with two compartments and two typical stretched canvases with three clamp assemblies attached placed individually into each compartment for transportation and protection

### DRAWING REFERENCE

### Components of the Clamp

101 Clamp body with threaded aperture

102 Finger grip surface of clamp body

103 Pointed protrusion of clamp body

104 Screw with appropriate finger grip surface

105 Pointed end of screw

106 Clamp body and screw assembly

### Exemplary Components of a Painter's Canvas Stretched and Attached to Typical Wooden Stretcher Bars

201 Typical fabric canvas used as a ground for an artist's painting

202 Typical wooden stretcher bar in standard profiles of varying lengths

203 Planar painting surface defined by top outer edges of stretched canvas

204 Uneven line represents wet paint freshly applied by an artist

205 Top outer edge of painting surface

### Exemplary Components of a Typical Painter's Easel

301 Typical upper bracket (vertically adjustable)

302 Typical lower bracket (stationary or vertically adjustable)

### Exemplary Components of a Container Compatible with the Clamps and Method

401 Bottom panel of appropriate container

402 Movable lid of appropriate container

403 Side panel of appropriate container

404 Movable lid in open position

405 Movable lid in closed/locked position

406 Twist lock in open position

407 Twist lock in closed position

408 Typical carry handle

### DETAILED DESCRIPTION

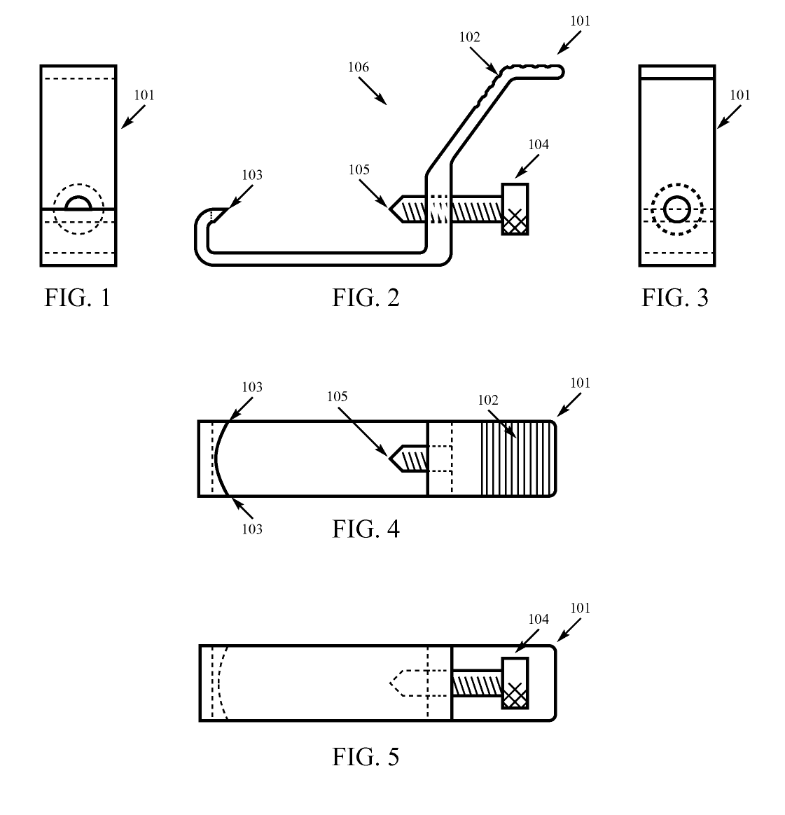

Selected embodiments are hereinafter described in detail in connection with the views and examples of FIGS. 1-13, appearing on Drawing sheets labeled 1/4, 2/4, 3/4, and 4/4. It is believed that certain embodiments of the clamps and methods will be understood from the following description taken in conjunction with sheets labeled 1/4, 2/4, 3/4, and 4/4.

An artist typically paints upon a conventional stretched canvas and regularly needs to handle, transport, and protect a freshly painted canvas while the paint is still wet and vulnerable to accidental damage.

The stretched canvas typically includes a frame constructed from four wooden members or stretcher bars attached together in a rectangular shape. A canvas is then stretched over a front surface of the frame and around the four exterior side surfaces of the frame, and is stapled or otherwise attached to the exterior or back surface of the frame. When attached to the frame, the canvas defines a planar painting surface, which is parallel with the front surface of the frame. An artist typically paints on the entire painting surface.

Clamps and methods are provided to seamlessly facilitate improved handling, transportation, and protection of freshly painted conventional stretched canvases, while requiring no contact whatsoever with the wet paint, including wet paint at the top outer edges of the painting surface. The illustrated clamp is shown to have a two-piece design, comprising an elongated body and a screw. The screw includes a point at the threaded end and is threadably received in a threaded aperture in the elongated body. The elongated body can be formed from aluminum, steel, stainless steel, or some other metal, or from non-metal material such as plastic, fiberglass, or a composite, for example. Similarly, the screw can be formed from aluminum, steel, stainless steel, or some other metal, or from non-metal material such as plastic, fiberglass, or a composite, for example. In one embodiment, the screw can comprise a thumb-type screw, and/or the head of the screw can be coated or capped with a resilient material (e.g., rubber or vinyl), or otherwise provided with a grip surface. It will be appreciated that the elongated body and/or screw can be provided in any variety of shapes, configurations, and dimensions alternative to those depicted.

In one embodiment, a kit includes multiple ones of the clamps such as, for example, a total of three clamps. Alternatively, a kit can include more than three clamps (e.g., five clamps), or less than three clamps (e.g., two clamps).

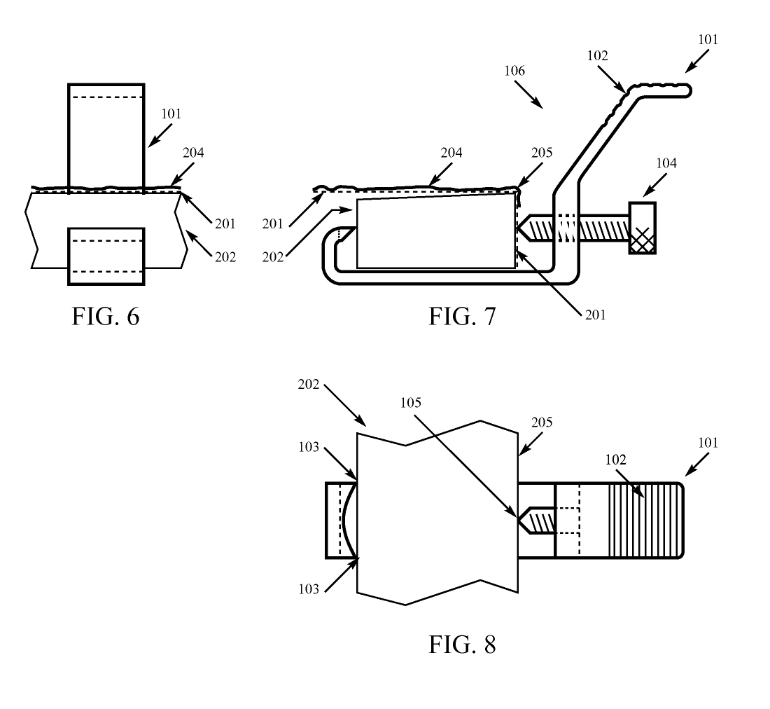

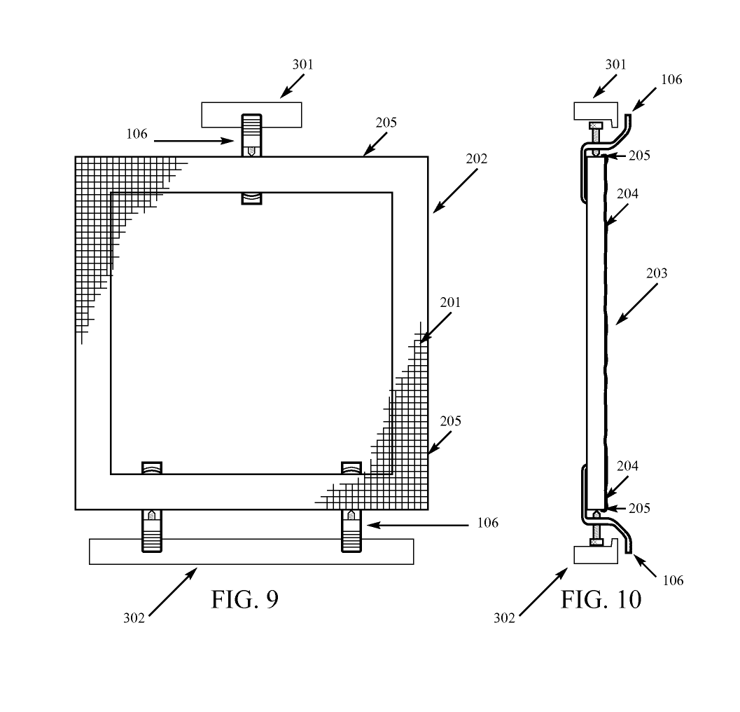

In use of the kit, the clamps can be attached to a stretched canvas by positioning the clamps as generally shown in FIGS. 6, 7, and 8, and tightening the screw of each respective clamp. In one embodiment as shown in FIGS. 9-13, an artist will attach the clamps to the stretched canvas prior to painting on the canvas, and will wait until all painting steps are complete, and the painting is dry to the touch or completely dry, before removing the clamps. In such a configuration, any handling and moving of the painting by the artist, prior to completion and drying of the painting, can be accomplished through contact by the artist with only the clamps, and without requiring the artist to directly contact the freshly painted canvas. Accordingly, the clamps can facilitate effective and convenient handling and transportation of a freshly painted canvas by an artist, while providing protection for the painting surface of the stretched canvas, whether paint on the canvas is wet or dry. While the clamps are shown for use with stretched canvas having generally rectangular shape, it will be appreciated that the same clamps or similar clamps can also or alternatively be used with a stretched canvas having any of a variety of other suitable shapes (e.g., oval).

It will be appreciated that, when so attached, the clamps can be shaped, sized and configured such that they do not touch the painting surface of the canvas, either in the front or rear, or at the top outer edge, as shown in FIG. 7. Therefore, attachment of the clamps does not interfere with an artist's ability to paint on the painting surface and in fact allows an artist to paint freely to all top outer edges of the painting surface without obstruction or interference.

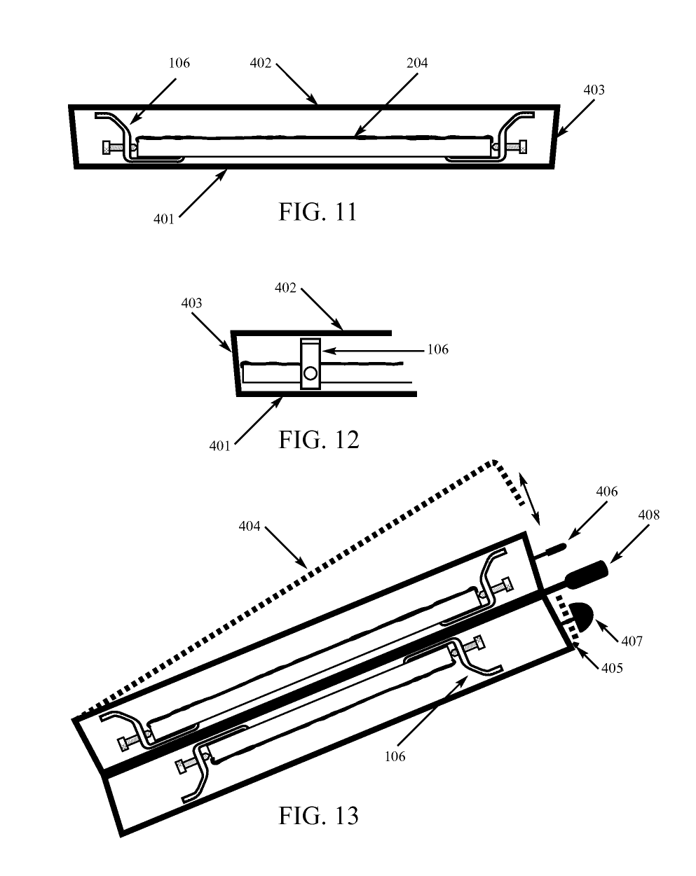

One end of the elongated body can include texture or knurling, as shown in FIGS. 2, 4, and 7-9, to facilitate effective gripping of the clamp by fingers of an operator's hand. When the clamp is attached to a stretched canvas, this same end of the elongated body can extend laterally and forward from the stretched canvas, such as to space the stretched canvas from an interior side wall of a container, and to space the painting surface of the stretched canvas from an interior top wall of a container, respectively, as shown in FIG. 11-13. The other end of the elongated body can have an arc-shape such that it contacts an interior side surface of the stretcher bar with two pointed protrusions of the clamp body at two spaced locations, as shown in FIG. 8, such as to provide enhanced stability.

With reference to FIGS. 6-13, use of as few as three clamps can prevent contact of the outer edge or other portion of the painting surface of the stretched canvas with a typical artist's easel, or any interior surface of a compatible container used to transport the stretched canvas. In fact, three clamps can completely support the stretched canvas with respect to an easel during the painting process, such that no portion of the stretched canvas contacts the easel (see FIGS. 9 and 10).

In one embodiment, as shown in FIG. 11-13, a box-type container can be formed from standard cardboard, moisture resistant cardboard, corrugated plastic material, or some other material, and can be selected to match the height of the clamps (as generally shown in FIGS. 11-13) with sufficient proximity that the painting surface does not contact the interior of the container during normal handling and transporting of the container. In one embodiment, (as generally shown in FIG. 12) the side walls of the container can be selected to be positioned at a slight outward angle from the bottom of the container to prevent the top outer edge of the painting surface of an unclamped side of the stretched canvas from contacting with the interior sides of the container.

In one embodiment (FIG. 13), a container can be provided with two separate compartments for carrying and protecting two paintings of different dimensions. A locking fixture can be provided to more fully secure the closed lids. A handle can also be provided to facilitate ease of carrying. It will be appreciated that a container with one or two compartments can be provided with both, or either a locking fixture and/or a handle.

In one embodiment, a clamp can be formed to accommodate all standard profiles of conventional canvas stretcher bars (see FIG. 7). However, in other embodiments, clamps can be available in different sizes and/or different configurations, with different ones of the clamps suitable to accommodate different ones of the standard profiles of conventional stretcher bars.

The foregoing description of embodiments and examples has been presented for purpose of illustration and description. It is not intended to be exhaustive or limiting to the forms described. Numerous modifications are possible in light of above teachings. Some of those modifications have been discussed, and others will be understood by those skilled in the art. The embodiments were chosen and described in order to best illustrate principles of various embodiments as are suited to particular uses contemplated. The scope is, of course, not limited to the examples set forth herein, but can be employed in any number of applications and equivalent devices by those of ordinary skill in the art.

1. A clamp assembly to improve handling, transportation, and protection of a freshly painted stretched canvas while requiring no contact with the wet paint, including wet paint at the top outer edges of the painting surface comprising:
an elongated body with threaded aperture;
pointed protrusions at one end of the elongated body;
a surface on the opposite end of the elongated body that can include texture or knurling to facilitate effective gripping of the body by fingers of an operator's hand;
a lateral extension of the elongated body at this same end that can space the painting surface of a stretched canvas from interior surfaces of top, side and bottom walls of a container;
a thumb-type screw with;
a point formed on the threaded end;
a head that can include texture or knurling to facilitate effective gripping of the screw by fingers of an operator's hand;
that is threadably received by the elongated body;
such that the pointed end of the screw is aligned opposite the pointed protrusions at one end of the body of the clamp; and
that the point of the screw converges toward the pointed protrusions of the body as the screw is tightened;
comprising a clamp assembly;
that can be attached to a standard wooden canvas stretcher bar;
by positioning the assembly in contact with surfaces of the stretcher bar; and
hand-tightening the screw such that;
the pointed protrusions at one end of the body engage an exposed surface of the stretcher bar beneath, and perpendicular to the painting surface; and
the pointed end of the screw engages an opposite side of the stretcher bar;
such that when canvas is stretched and attached to a wooden frame consisting of a rectangular configuration of joined stretcher bars that then provide a rectangular planar painting surface defined by the top outer edges of the stretched canvas;
the assembly contacts the stretcher bar surfaces without contacting the painting surface of the stretched canvas including the top outer edge of the painting surface of the stretched canvas;
such that the entire painting surface is unobstructed and available to paint; and
such that the stretched canvas can be handled by an operator gripping only the lateral extension end of the clamp assembly;
such that any wet paint on the painting surface of the stretched canvas, including any wet paint on the top outer edges of the painting surface can remain untouched during handling and transporting of the stretched canvas.

2. A method of facilitating handling, transportation, and protection of a freshly painted stretched canvas while requiring no contact with the wet paint, including wet paint at the top outer edges of the painting surface, method comprising:
attaching a first clamp assembly to the stretched canvas;
attaching a second clamp assembly to the stretched canvas;
attaching a third clamp assembly to the stretched canvas; and
handling the stretched canvas through use of the first clamp assembly, the second clamp assembly, and the third clamp assembly; and
placing the stretched canvas into an appropriate closable container;
wherein each of the first clamp assembly, second clamp assembly, and third clamp assembly comprise an elongated body with a lateral extension of one end and a screw being threadably received in a threaded aperture in the elongated body; and
wherein the container is of a form that permits the lateral extension of the elongated body to space the painting surface away from the interior surfaces of the closed container;
thereby facilitating improved handling, transportation, and protection of a freshly painted stretched canvas while the wet paint is vulnerable to accidental damage and unwanted debris.
